(19) United States
(12) Patent Application Publication
(10) Pub. No.: US 2008/0062512 A1
(43) Pub. Date: Mar. 13, 2008

(54) Confocal electroluminescence spectral microscope

(75) Inventors: Sang Su Hong, Suwon (KR); Bae Kyun Kim, Sungnam (KR); June Sik Park, Yongin (KR); Grigory Onushkin, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO MECHANICS CO., LTD

(21) Appl. No.: 11/896,530

(22) Filed: Sep. 4, 2007

(30) Foreign Application Priority Data
Sep. 8, 2006 (KR) 10-2006-86787

(51) Int. Cl. G02B 21/06

(52) U.S. Cl. 359/385

(57) ABSTRACT

A confocal electroluminescence spectral microscope including: a base board where an object including a material capable of emitting light is mounted; a power supply supplying current to enable the object mounted on the base board to electrically emit light; a confocal lens disposed above the base board to receive the light emitted from the object; a detection part disposed above the confocal lens to obtain energy distribution with respect to the light emitted from the object; and a pin hole disposed between the confocal lens and the detection part to allow a luminescence signal for a confocal point formed on a target surface of the object.

### CROSS-REFERENCE TO RELATED APPLICATIONS

This application claims the priority of Korean Patent Application No. 2006-86787 filed on Sep. 8, 2006, in the Korean Intellectual Property Office, the disclosure of which is incorporated herein by reference.

### BACKGROUND OF THE INVENTION

1. Field of the Invention

The present invention relates to a confocal microscope, and more particularly, to a confocal electroluminescence spectral microscope capable of obtaining a luminescence spectrum and a luminescence distribution from an electroluminescent and photoluminescent object.

2. Description of the Related Art

A device for measuring electroluminescence characteristics for an electroluminescent device includes a device for measuring an intensity distribution of electroluminescence of the electroluminescent device, and an electroluminescence spectrometer. The device for measuring the intensity distribution of electroluminescence allows current to flow to the electroluminescent device thereby to emit light and detects the emitted light via a charge-coupled device (CCD). On the other hand, the electroluminescence spectrometer spectrally splits a luminescence signal of a certain point of the electroluminescent device and obtains a luminescence spectrum with respect to the point. However, the device for measuring the intensity distribution of electroluminescence and the electroluminescence spectrometer, which are divided as described above, have not been integrated so far.

In general, a confocal laser scanning microscope scans a point laser light source on a surface of an object, collects light transmitted or reflected, and obtains information about the object from the light.

The confocal laser scanning microscope has been mainly used to decipher information of bio-materials having an excitable fluorescent material by energy of the laser light source.

FIG. 1 is a configuration view illustrating an electroluminescence image measuring device according to the prior art.

Referring to FIG. 1, for the device to measure a distribution image of electroluminescence intensity, a power 12 is supplied to an object 11 to allow light emitted from the object 11 to be incident on a charge coupled device (CCD) 14 through lenses 13a and 13b.

In the conventional electroluminescence analyzer, it is impossible to compare a spatial distribution of split spectrums of the electroluminescent device with a mechanical external structure of the device. Moreover, an electroluminescence image detector of FIG. 1 hardly measures a high-resolution electroluminescence image.

### SUMMARY OF THE INVENTION

An aspect of the present invention provides an electroluminescence spectral microscope which assures both split spectrums of an electroluminescent device and a mechanical structure thereof, and a high-resolution electroluminescence image.

According to an aspect of the present invention, there is provided a confocal electroluminescence spectral microscope including: a base board where an object including a material capable of emitting light is mounted; a power supply supplying current to enable the object mounted on the base board to electrically emit light; a confocal lens disposed above the base board to receive the light emitted from the object; a detection part disposed above the confocal lens to obtain energy distribution with respect to the light emitted from the object; and a pin hole disposed between the confocal lens and the detection part to allow a luminescence signal for a confocal point formed on a target surface of the object.

The confocal electroluminescence spectral microscope may further include a two-dimensional transfer unit transferring the confocal point formed on the target surface of the object along the target surface of the object.

The confocal electroluminescence spectral microscope may further include a vertical transfer unit transferring the confocal lens to move the target surface of the object in a thickness direction of the object.

The confocal electroluminescence spectral microscope may further include a laser light source supplying a photon with energy capable of enabling the object to emit light; and a light director disposed between the confocal lens and the pin hole to direct a beam from the laser light source toward the confocal lens and to direct the light generated from the object by the photon and the current toward the pin hole.

The light director may be a dichroic beam spectrometer reflecting the beam from the laser light source and transmitting light with other energy.

The detection part may include: a monochromator including an optical device, the monochromator dispersing the light received from the object for each wavelength; and a detector measuring energy distribution of a signal from the monochromator.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration view illustrating an electroluminescence distribution detector according to the prior art.

FIG. 2 is a configuration view illustrating a confocal electroluminescence spectral microscope according to an exemplary embodiment of the invention;

FIG. 3 is a configuration view illustrating a confocal electroluminescence spectral microscope according to an exemplary embodiment of the invention;

FIGS. 4A and 4B illustrate a current intensity distribution of a luminescent device and a spectrum of photon energy at a certain point thereof, respectively, measured by a confocal electroluminescence spectral microscope according to the invention;

FIGS. 5A through 5C are explanatory views illustrating a difference between a conventional electroluminescence measuring device and an electroluminescence image measuring device according to the invention;

FIGS. 6A through 6C illustrate a structural configuration of a luminescent device, a current intensity distribution thereof and an energy spectrum thereof at a certain point, respectively, measured by a confocal electroluminescence spectral microscope according to the invention; and

FIGS. 7A through 7C illustrate a test electrode pattern, an electroluminescence intensity distribution with respect to the electrode pattern measured by a confocal electroluminescence spectral microscope, and a graph showing a decrease in electroluminescence intensity, respectively.

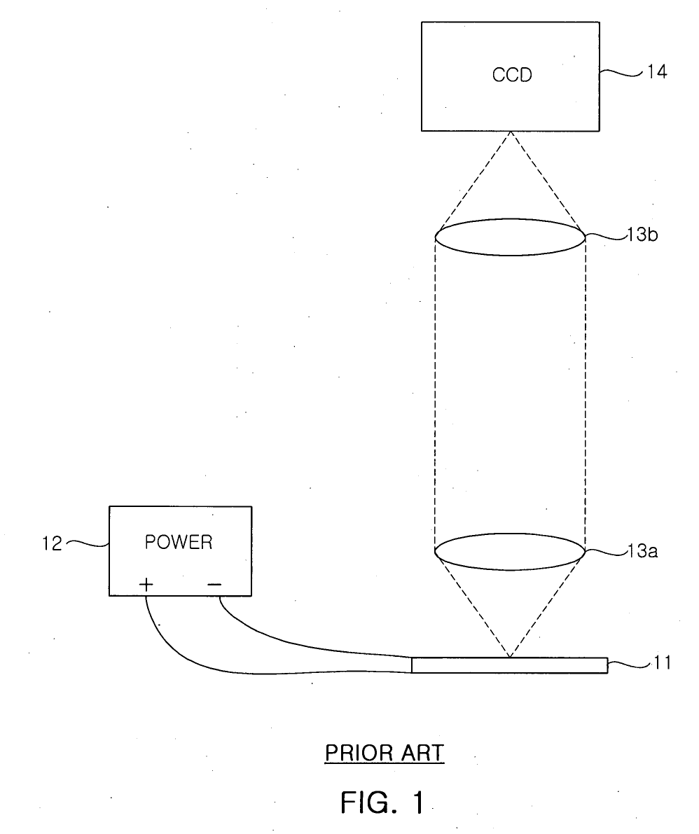

### DETAILED DESCRIPTION OF THE PREFERRED EMBODIMENT

Exemplary embodiments of the present invention will now be described in detail with reference to the accompanying drawings.

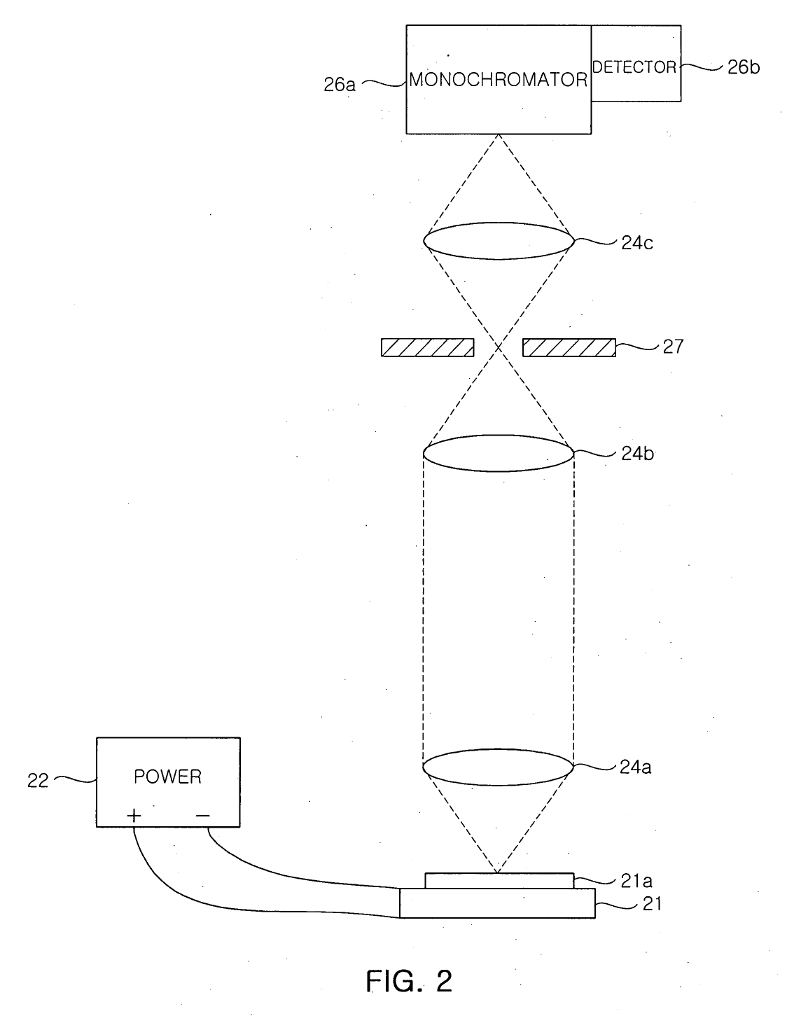

FIG. 2 is a configuration view illustrating a confocal electroluminescence spectral microscope according to an exemplary embodiment of the invention.

Referring to FIG. 2, the confocal electroluminescence spectral microscope includes a power supply 22, a base board 21, a confocal microscope part 24a,24b,24c, and 27, and a detection part 26a and 26b.

An object 21a containing a luminescent material is placed on the base board 21. The object 21a may be a nitride semiconductor device.

The object 21a is not merely disposed on the base board 21 but connected to the power supply 22 to be supplied with a power for emitting light. The power supply 22 is directly connected to the base board 21. Here, the base board 21 and the object 21a are electrically connected with each other and thus the power supply 22 is electrically connected to the object 21a to enable the object 21a to electrically emit light.

A confocal lens 24a, a pin hole 27 and the detection part 26a and 26b are disposed above the base board where the object 21a is placed, thereby constituting the confocal microscope.

The confocal lens 24a receives light emitted from the object 21a. The light emitted from the object 21a propagates in a parallel direction through the confocal lens 24a and is collected by a collecting lens 24b and guided to the pin hole 27.

At this time, a focal point is formed on a surface of the object 21a by the confocal lens 24a. The pin hole 27 is confocal with the focal point.

Particularly, only the light emitted from the focal point formed on the surface of the object 21a by the confocal lens 24a may be propagated to the detection part 26a and 26b. With the pin hole 27 disposed, only the light emitted from a certain point of the object is received to enhance image resolution of the confocal microscope.

That is, the pin hole 27 allows passage of only the light emitted from the focal point formed on the surface of the object 21a, and interrupts light emitted from an adjacent area. Therefore, even in a case where the object 21a emits light with high brightness, a luminescence image for only a desired area is obtainable.

The light passing through the pin hole 27 is collected by the light collecting lens 24c and guided to a detection part 26a and 26b.

The detection part 26a and 26b includes a monochromator 26a dispersing the received light for each wavelength and a detector 26b measuring a distribution of the light dispersed for each wavelength. The light distribution detected by the detector 26b is transmitted to a displayer such as an externally connected monitor.

The monochromator 26a has a dispersion optical system such as a prism or a diffraction grating disposed therein, thereby dispersing the light propagating through the pin hole 27 for each wavelength.

The light dispersed in this fashion is detected by the detector 26b. The detector 26b, if controlled to detect a certain portion of the dispersed wavelengths, produces an electroluminescence spectrum of the focal point formed on the target surface of the object 21a.

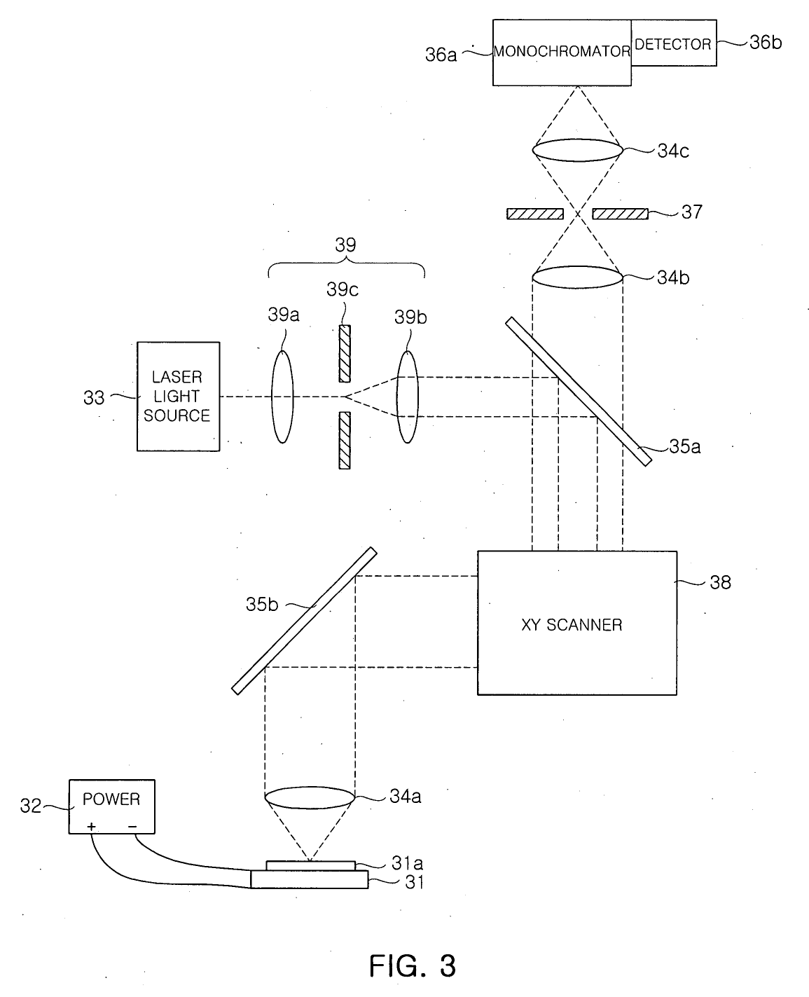

FIG. 3 is a configuration view illustrating a confocal electroluminescence spectral microscope according to an exemplary embodiment of the invention.

Referring to FIG. 3, the electroluminescence spectral microscope according to the present embodiment further includes a laser light source 33 and an XY scanner 38 in the electroluminescence spectral microscope described with reference to FIG. 2. Since the power supply 32, base board 31, confocal lens 34a, pin hole 37 and detection part 36a and 36b have been described with reference to FIG. 2, only additional components will be explained.

According to the present embodiment, the electroluminescence spectral microscope further includes an XY scanner 38 shifting a focal point formed on a surface of an object 31a by a confocal lens 34a along the surface of the object 31a.

The XY scanner 38 scans the surface of the object 31a along a certain track on the surface of the object 31a. This two-dimensional scanning my be realized by transferring an optical structure such as a base board 31 where the object 31a is mounted or the confocal lens 34a, in case of absence of the XY scanner. Particularly, a known galvano scanner may be employed as the XY scanner.

As described above, the surface of the object 31a is scanned to obtain an electroluminescence spectral image of an entire surface of the object and an electroluminescence spectral spectrum at a certain point of the object, in a monochromator 36a and a detector 36b.

After scanning is performed along the surface of the object, a focal point is shifted in a depth direction of the object to obtain optical information about another target surface. Such a vertical transfer unit is implemented by transferring the confocal lens 34a vertically with respect to the surface of the object and adjusting a vertical position of the confocal point.

As described above, two-dimensional scanning for the one target surface and additional selective two-dimensional scanning for the another target surface may be performed repeatedly to enable information about a three-dimensional space to be interpreted. Particularly, in case of measuring a nitride semiconductor wafer, an active layer is analyzable three-dimensionally. Accordingly, a luminescence wavelength in the overall active layer may be evaluated based on a high three-dimensional resolution.

According to the present embodiment, the electroluminescence spectral microscope further includes a laser light source 33.

The laser light source 33 of the present embodiment should generate a beam with energy capable of exciting a luminescent material included in the object 31a. Also, a subpico-second pulse beam should be irradiated to excite the luminescent material by one of a single photon and a multi photon.

Lenses 39a and 39b and a pin hole 39c are disposed in front of the laser light source 33. Therefore, the beam generated from the laser light source 33 is directed more precisely toward a light director 35a.

According to the present embodiment, the electroluminescence spectral microscope further includes the light director 35a.

The confocal lens 34a serves as a light collector for imaging the beam from the laser light source 33 on the target surface of the object 31a disposed on the base board 31 and as a light receiver for receiving the light generated from the object 31a. In this structure, the electroluminescence spectral microscope may further include a vertical transfer unit (not shown) vertically transferring the confocal lens 34a so that the target surface moves in a thickness direction of the object 31a.

The light director 35a of the present embodiment directs the beam from the laser light source 33 toward the confocal lens 34a and the light generated from the object 31a toward a light collecting lens 34b to collect light in the pin hole 37.

Particularly, the light director 35a may be formed of a dichromatic beam spectrometer. The dichromatic beam spectrometer has selectivity for wavelength. In the present embodiment, the dichromatic beam spectrometer is disposed to reflect the beam from the laser light source 33 and transmit the light generated from the object 31a.

A mirror 35b disposed between the XY scanner 38 and the confocal lens 34b functions differently from the light director 35a. That is, the mirror reflects both the laser beam passing through the XY scanner 35b and the light emitted from the object 31a thereby to alter an optical path.

In this fashion, the confocal scanner electroluminescence spectral microscope dramatically enhances spatial resolution over a conventional CCD-based electroluminescence image measuring device. The confocal scanner electroluminescence spectral microscope of the present embodiment is a unique device for analyzing electroluminescent device characteristics, incorporating function of a conventional luminescence spectrum device with function of a confocal laser scanning fluorescent microscope. The confocal scanning electroluminescence spectral microscope of the present embodiment allows simultaneous measurement, analysis and comparison of a structural shape, an electroluminescence distribution profile, an electroluminescence spectrum distribution profile, an optical luminescence distribution profile, an optical luminescence spectrum distribution profile with respect to the electroluminescent device as the object.

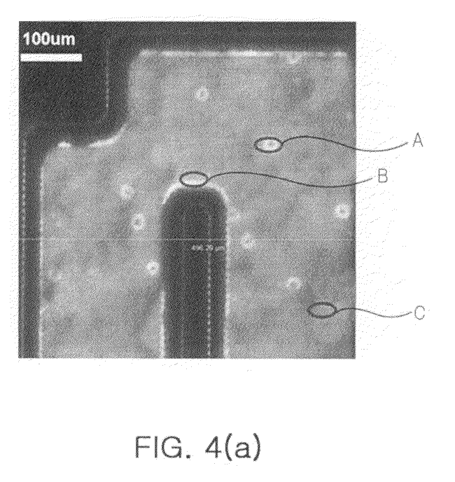

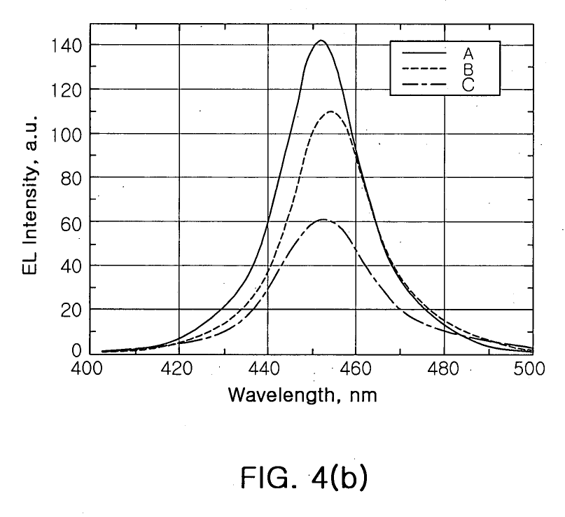

FIGS. 4A and 4b illustrate a measurement result of an InGaN/GaN blue chip using a confocal electroluminescence spectral microscope according to the present embodiment.

FIG. 4A illustrates an overall electroluminescence distribution of the chip.

To obtain this image, the GaN/GaN blue LED chip was placed on a base board and 5 mA current was supplied via a power supply to enable the LED chip to electrically emit light and then an entire surface of the chip was scanned using an XY scanner.

Luminescence distribution across the LED chip obtained by the scanning was detected by a monochromator and a detector. As in the present embodiment, luminescence distribution across the LED chip by scanning may be directly detected by the detector without the monochromator. Here, the detector was adjusted to detect an entire region of wavelengths dispersed by the monochromator.

FIG. 4B illustrates electroluminescence spectrums at A, B and C marked in FIG. 4A.

To obtain the spectrum, the detector was adjusted to selectively detect only a certain region of wavelengths dispersed by the monochromator.

Referring to FIG. 4B, A exhibited a maximum electroluminescence intensity of 141 [a.u.] at a wavelength of 451 nm. Also, B demonstrated a maximum electroluminescence intensity of 110 [a.u.] at a wavelength of 455 nm and C exhibited a maximum electroluminescence intensity of 60 [a.u.] at a wavelength of 452 nm. This difference is analyzed to result from difference in current density according to locations of the object.

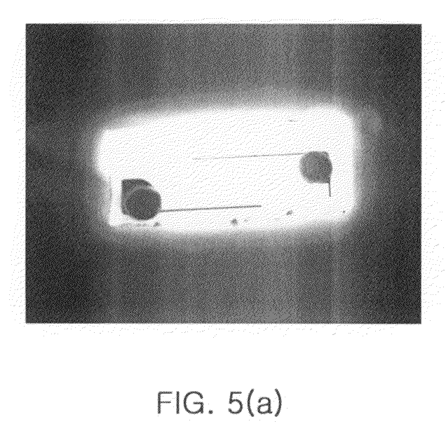

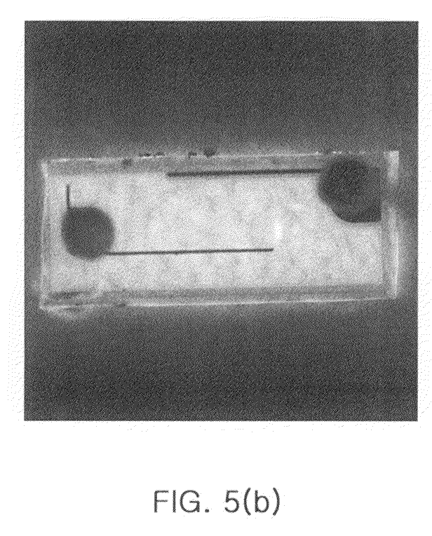

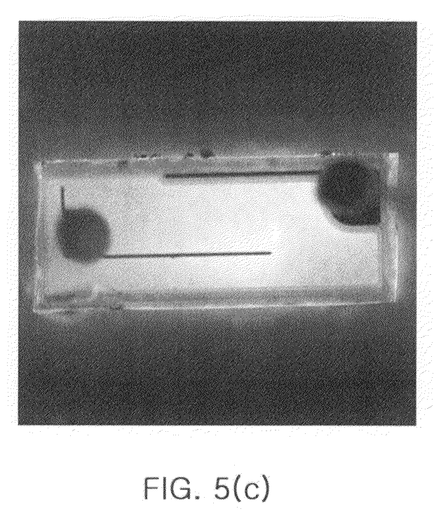

FIGS. 5A through 5C are views for explaining difference between a conventional electroluminescence measuring device and an electroluminescence image measuring device according to an exemplary embodiment of the invention.

FIG. 5A illustrates a measurement result of light generated from an object capable of electrically emitting light by 1 mA current supplied, using the conventional electroluminescence image measuring device. Strong light generated from the object was observed to be diffused even to the outside of the LED, thus rendering the shape of the LED hardly discernable.

FIGS. 5B and 5C illustrate measurement results of electroluminescence distribution profiles by supplying 1 mA current and 100 mA current to an identical object, respectively, and performing confocal-scan of light generated from the object capable of electrically emitting light by the current, using the confocal electroluminescence spectral microscope as shown in FIG. 3. The confocal point was shifted along a target surface of the object to allow clear analysis of electroluminescence distribution profiles of the object despite strong intensity of the light generated from the object, as opposed to FIG. 5A.

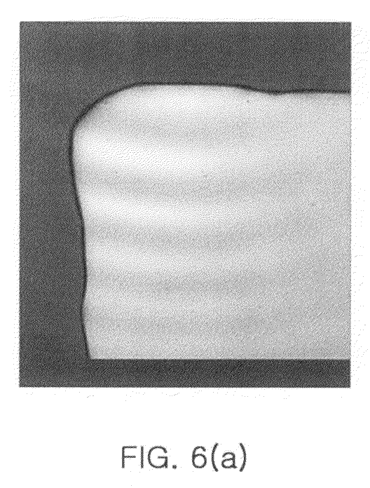

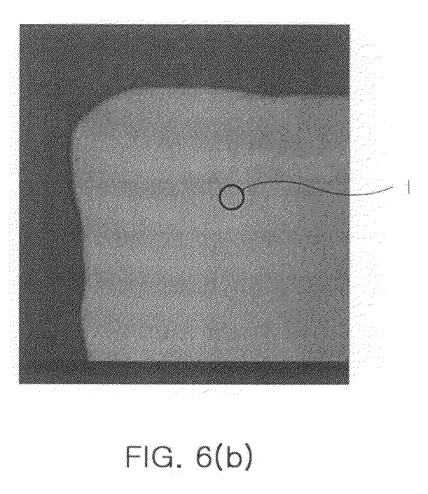

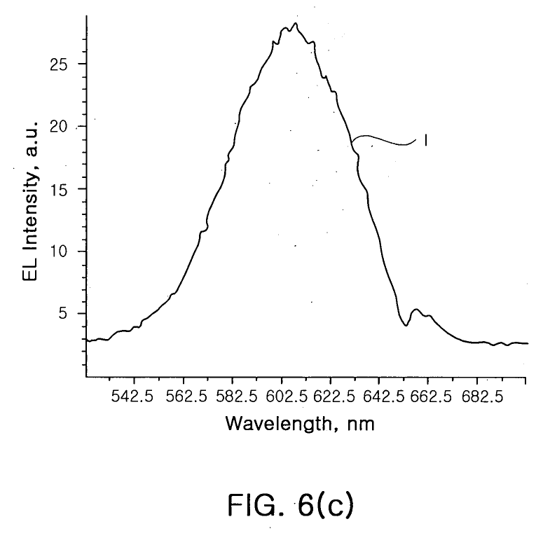

FIGS. 6A through 6C illustrate a measurement result of luminance characteristics of an organic electroluminescence (OLED) device emitting red light with a wavelength of 623 nm, using a confocal electroluminescence microscope of the present invention.

FIG. 6A illustrates a structural shape of an object detected via a monochromator and a detector by enabling the object to emit light by a laser light source and scanning a surface of the object by an XY scanner.

FIGS. 6B and 6C illustrate an electroluminescence distribution profile of the object obtained by supplying 5 mA current and scanning light generated from the object capable of electrically emitting light by the current, and an electroluminescence spectrum at a certain point (I) of the object.

As described above, according to the present embodiment, the con-focal electroluminescence spectral microscope allows simultaneous measurement, analysis and comparison of a structural shape, an electroluminescence distribution profile and an electroluminescence spectrum distribution profile with respect to the electroluminescent device as the object.

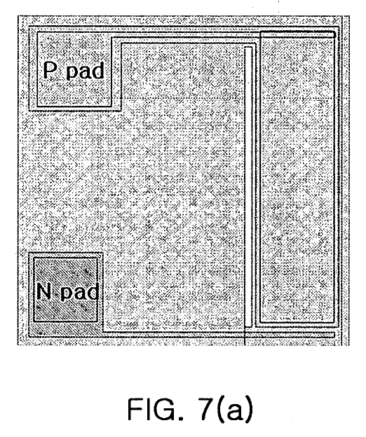

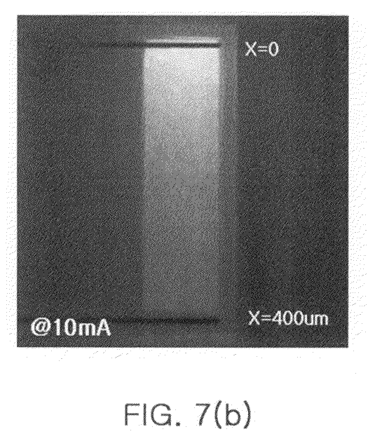

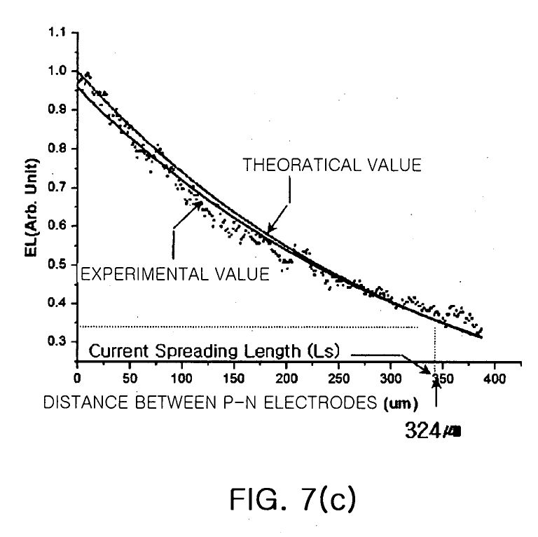

FIGS. 7A through 7C illustrate an LED chip pattern, an electroluminescence intensity distribution of the chip and a graph showing current density distribution between electrodes, respectively.

Conventionally, a current spreading distance has been only theoretically calculated but not experimentally confirmed. According to the present embodiment, local electroluminescence intensity distribution measured enables indirect measurement and evaluation of current density distribution since electroluminescence intensity is proportional to current density.

To measure current density diffusion distance through electroluminescence intensity distribution, in the present embodiment, as shown in FIG. 7A, a test chip electrode pattern was designed such that a p-electrode and an n-electrode are spaced apart from each other in parallel.

FIG. 7B illustrates a measurement result of electroluminescence intensity distribution between the p-electrode and n-electrode after supplying 10 mA current to the test chip. As shown in FIG. 7B, the p-electrode and n-electrode were spaced apart at a distance of 100 μm. In a direction from the p-electrode to the n-electrode, the chip was shown less bright. This indicates decrease in electroluminescence intensity.

FIG. 7C illustrates a measurement result of decrease in electroluminescence intensity with a greater distance from the p-electrode. That is, increase in the distance between the p-and n-electrodes exponentially lowers electroluminescence intensity.

A theoretical value shown in FIG. 7C was analyzed using a following equation:

I=I_{O} exp(−χ/Ls)

where Ls denotes a current spreading distance. Data on decrease in the measured electroluminescence intensity is applicable to the above equation to determine the current spreading distance and the Ls value. According to the present embodiment, the current spreading distance Ls was determined to be 324 μm.

This method will be beneficially utilized in not only inorganic LEDs but also organic LEDs to design an electrode structure where current spreading is more effective and uniform.

The present invention is not limited to the aforesaid embodiments and accompanying drawings. That is, the laser and scanner may be arranged variously, and the reflective mirror and light collecting lens may be configured variously.

As set forth above, according to exemplary embodiments of the invention, a con-focal electroluminescence spectral microscope is excellent in spatial resolution for an electroluminescent device. Also, the con-focal electroluminescence spectral microscope allows simultaneous measurement of structural information, optical luminance characteristics and electroluminescence characteristics of a luminescent device as an object.

While the present invention has been shown and described in connection with the exemplary embodiments, it will be apparent to those skilled in the art that modifications and variations can be made without departing from the spirit and scope of the invention as defined by the appended claims.

What is claimed is:

1. A confocal electroluminescence spectral microscope comprising:
a base board where an object including a material capable of emitting light is mounted;
a power supply supplying current to enable the object mounted on the base board to electrically emit light;
a confocal lens disposed above the base board to receive the light emitted from the object;
a detection part disposed above the confocal lens to obtain energy distribution with respect to the light emitted from the object; and
a pin hole disposed between the confocal lens and the detection part to allow a luminescence signal for a confocal point formed on a target surface of the object.

2. The confocal electroluminescence spectral microscope according to claim 1, further comprising a two-dimensional transfer unit transferring the confocal point formed on the target surface of the object along the target surface of the object.

3. The confocal electroluminescence spectral microscope according to claim 1, further comprising a vertical transfer unit transferring the confocal lens to move the target surface of the object in a thickness direction of the object.

4. The confocal electroluminescence spectral microscope according to claim 1, further comprising a laser light source supplying a photon with energy capable of enabling the object to emit light.

5. The confocal electroluminescence spectral microscope according to claim 4, further comprising a light director disposed between the confocal lens and the pin hole to direct a beam from the laser light source toward the confocal lens and to direct the light emitted from the object by the photon and the current toward the pin hole.

6. The confocal electroluminescence spectral microscope according to claim 5, wherein the light director is a dichroic beam spectrometer reflecting the beam from the laser light source and transmitting light with other energy.

7. The confocal electroluminescence spectral microscope according to claim 1, wherein the detection part comprises:
a monochromator including an optical device, the monochromator dispersing the light received from the object for each wavelength; and
a detector measuring energy distribution of a signal from the monochromator.
